(19) United States
(12) Patent Application Publication
(10) Pub. No.: US 2009/0208912 A1
(43) Pub. Date: Aug. 20, 2009

(54) Process that produces two-dimensional symbols from words

(76) Inventor: Susan Kathryn Voigt, Sleepy Hollow, IL (US)

Correspondence Address: Susan K. Voigt, 209 Rainow Drive, Sleepy Hollow, IL, 60118, US

(21) Appl. No.: 12/070,318

(22) Filed: Feb. 19, 2008

(51) Int. Cl. G09B 19/00

(52) U.S. Cl. 434/156

(57) ABSTRACT

A process that occurs within a border made up of the twenty-six-letter English alphabet that produces two-dimensional symbols from words by creating one continuous line from the first letter of a word being processed to the next letter of the same word being processed. This process continues in one unbroken line until the last letter of the word being processed has been reached. Once the last letter of the word being processed has been reached, the process stops.

### BACKGROUND OF THE INVENTION

Keeping school age kids excited about practicing their weekly spelling words is challenging. This invention is a unique process that invites children to learn as they play. The two-dimensional symbols this process produces will also be used for decorative purposes. Words we are accustomed to reading by way of a linear alphabet will grace t-shirts, posters, and a variety of other useful and functional items by way of symbols that are created with this process. In addition to helping children learn and bringing unique products to the marketplace, this invention helps integrate the right and left hemispheres of the brain.

In his book entitled The Alphabet Versus The Goddess, Leonard Shlain posits, “Literacy reinforces the brain's linear left hemisphere at the expense of the holistic right hemisphere.” (http://www.childrenofthecode.org/interviews/shlain.htm) Wikepedia explains this further by stating, “Linear reasoning functions of language such as grammar and word production are often lateralized to the left hemisphere of the brain. In contrast, holistic reasoning functions of language . . . are often lateralized to the right hemisphere of the brain . . . functions such as visual stimuli, spatial manipulation, and artistic ability.” (http://en.wikipedia.org/wiki/Lateralization_of_brain_function) Michael Erickson, when speaking of the Visual Literacy Project suggests, “Getting “stuck” thinking only one way (or from one perspective) limits our options and the kinds of solutions we can come up with. (http://members.tripod.com/˜michael_erickson/main/the-issue.htm) The Internet site Holistic Junction suggests “whole brain thinking” as a solution to Erickson's concerns about “getting stuck” and describe, “The two cerebral hemispheres of the brain unify to create a “whole brain thinking” pattern.” They say, “Using whole brain thinking enhances living, logic, intuition, analytical skills, mechanical reasoning, and artistic ability.” (http://www.holisticjunction.com/categories/HPD/whole-brain-thinking.html) Again, Wikepedia sheds a bit more light on the subject. They suggest, “Other integrative functions such as intuitive or heuristic . . . seem to be more bilaterally controlled. (http://en.wikipedia.org/wiki/Lateralization_of_brain_function) For more than 30 years and in over 80 countries, Brain Gym has been creating and marketing products that stimulate whole brain thinking with a technique they call “crossing the midline.” (http://www.braingym.org/) Dr. Don Dorsey, in an interview with Healing Resources, addresses the fact that trauma is held in the right hemisphere of the brain. In this interview he discusses a technique called EMDR. He explains EMDR as being, “A strategy that uses bilateral stimulation. It generates a crossover from right to left hemisphere.” Dr. Dorsey suggests that, “Healing of trauma is movement of information, or memory, from right hemisphere to left hemisphere.” (http://www.healingresources.info/video_dondorsey.htm)

Right and left hemispheres of the brain will be stimulated by this invention as both a linear word and a two-dimensional symbol that represents the same word will be presented and processed at the same time.

### BRIEF SUMMARY OF THE INVENTION

This invention is a process that produces two-dimensional symbols within a border made up of the twenty-six-letter English alphabet. As an educational aid, this invention will encourage children to enjoy studying their spelling words. As a producer of novel design symbols, this invention will provide graphics that will grace t-shirts, posters, and many other useful and functional items. As a producer of designs that stimulate both right and left hemispheres of brain, this process will encourage “whole brain thinking” as well as communication “across the midline.”

### BRIEF DESCRIPTION OF THE SEVERAL VIEWS OF THE DRAWING

FIG. 1: This drawing depicts process having been generated on the word Peace within a border made up of the twenty-six-letter English alphabet.

FIG. 2: This drawing depicts two-dimensional Peace symbol, absent of border made up of the twenty-six-letter English alphabet, alongside linear Peace word which two-dimensional Peace symbol represents.

### DETAILED DESCRIPTION OF THE INVENTION

This invention is the process of producing two-dimensional symbols from words by creating one continuous line from the first letter of a word being processed to the next letter of the same word being processed. This process continues in one unbroken line until the last letter of the word being processed has been reached. Once the last letter of the word being processed has been reached, the process stops.

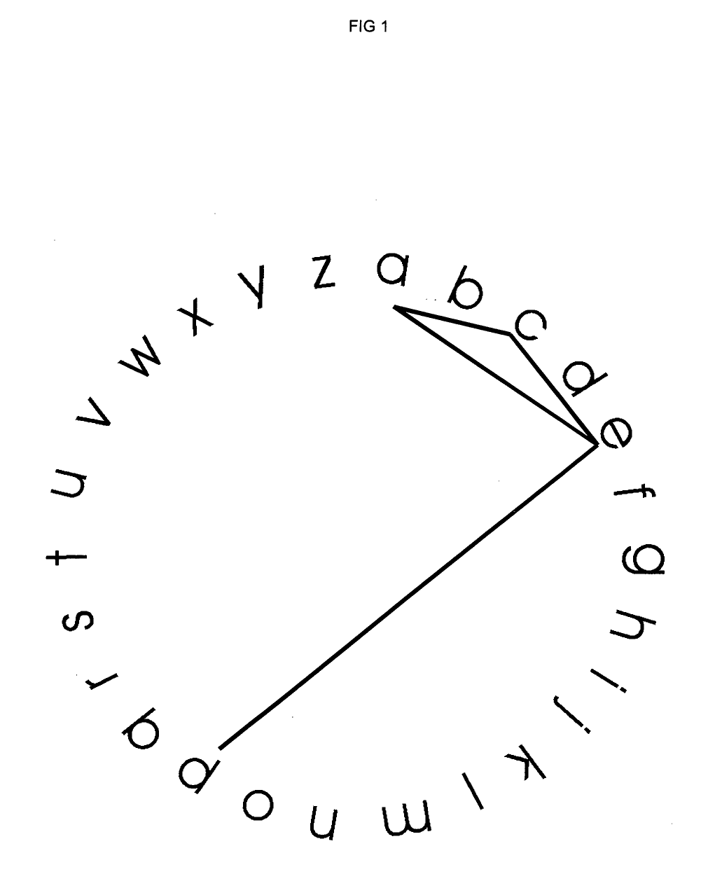

This process takes place within the confines of a border made up of the twenty-six-letter English alphabet. This invention is the process of taking, for example, the word “Peace,” (refer to drawing FIG. 1) and drawing one continuous, unbroken line that begins at the letter “P,” extends to the letter “e,” continues on from “e” to “a,” from “a” to “c,” from “c” to “e,” and then ends at “e.”

This process may be applied to an infinite number of words thereby creating an infinite number of associated symbols. This process may be exercised by hand with a pencil, pen, or any other marking utensil on a piece of paper, a piece of chalk or any other marking utensil on a chalkboard, or a dry-erase marker or any other marking utensil on a dry-erase board, This process may also be generated by computer or by way of any other materials that yield a visible two-dimensional symbol.

The border made up of the twenty-six-letter English alphabet (refer to drawing FIG. 1) can be hand drawn, stamped or printed with ink, painted, or manufactured in any way so as to create a visible border of the twenty-six-letter English alphabet. This said border, made up of the twenty-six-letter English alphabet, provides letter points of contact for the two-dimensional symbol created by this process as well as a boundary within which one continuous, unbroken line can produce the two-dimensional symbol created by this process. This invention request however, is solely to protect the process of drawing one unbroken line, within a border made up of the twenty-six-letter English alphabet, thereby producing two-dimensional symbols from words.

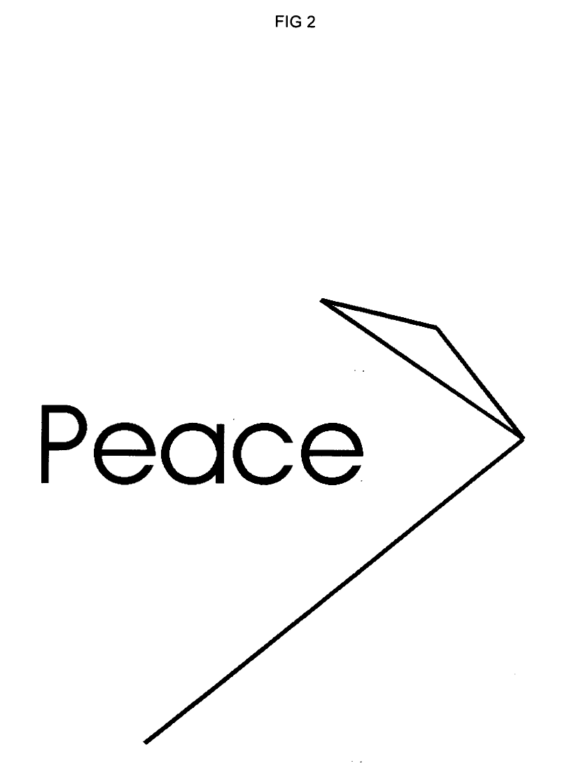

The twenty-six-letter English alphabet is a linear alphabet. A process is in place to spell words using this linear alphabet. This process reproduces and rearranges the individual letters themselves to produce linear words used for reading alone or within linear sentences. This invention is distinguishable because it dispenses with all things linear. By utilizing a border made up of the twenty-six-letter English alphabet, and then spelling words by creating one continuous line that connects the individual letters to each other rather than by reproducing and rearranging the individual letters themselves, this process produces two-dimensional symbols (refer to drawing FIG. 1) rather than linear words. This process produces two-dimensional symbols that will be displayed alongside the linear words they represent. (refer to drawing FIG. 2)

What is claimed is:

1. A process that produces two-dimensional symbols from words by creating one continuous line from the first letter of a word being processed, to the next letter of the same word being processed, and continuing in one unbroken line until the last letter of the word being processed has been reached, at which point the process stops.

2. The process of claim 1 that utilizes a border made up of the twenty-six-letter English alphabet in order to establish a boundary within which to produce an infinite number of two-dimensional symbols from an infinite number of words.
